(19) United States
(12) Patent Application Publication
(10) Pub. No.: US 2026/0307808 A1
(43) Pub. Date: Oct. 8, 2026

(54) LEADING EDGE OF AN AIRCRAFT PART AND PROCESS FOR FORMING A LEADING EDGE

(71) Applicants: Airbus Operations GmbH, Hamburg (DE); Airbus (S.A.S.), Blagnac Cedex (FR)

(72) Inventors: Blanka Lenczowski, Hamburg (DE); Peter Linde, Hamburg (DE)

(21) Appl. No.: 19/460,731

(22) Filed: Jan. 27, 2026

(30) Foreign Application Priority Data
Jan. 28, 2025 (DE) 102025103066.9

(51) Int. Cl. B64D 15/12; H05B 3/14

(52) U.S. Cl. CPC B64D 15/12; H05B 3/141; H05B 3/145; H05B 2203/013; H05B 2203/017

(57) ABSTRACT

A leading edge of an aircraft part, at least including a base layer, a functional layer applied on the base layer, and a final layer applied on the functional layer, wherein the functional layer includes in each case at least one first layer formed from carbon nanotubes, and at least one second layer formed from titanium particles and or from titanium nitride particles, wherein the carbon nanotubes are provided to electrically conductively connect the titanium particles and/or titanium nitride particles of the at least one second layer, and also to a process for forming such a leading edge.

### TECHNICAL FIELD

The disclosure herein relates to a leading edge of an aircraft part and to a process for forming a leading edge.

The disclosure herein and the problems underlying it, despite its employability in many sectors, are explained more particularly with regard to aircraft or aircraft parts. The described apparatuses and the process are however also employable for parts of stationary units, for example of wind turbines, and of vehicles in all areas of transport (but not limited thereto), for example for road vehicles, for rail vehicles or for watercraft.

### BACKGROUND

For reasons of weight saving and extension of maintenance intervals, a gradual transition is envisaged to main structural components of the aircraft, such as the fuselage, the wings, the empennage and claddings, being made of carbon-fiber-reinforced plastic (CFRP). Aircraft having CFRP wings are already being used in civil aviation.

The leading edges of wings, empennages or other aerodynamic components that have first contact with the air flow can over a long period of time become eroded by water droplets entrained in the airflow during rainy flight conditions or by dust particles in the air. Flights to regions where there are sand particles in the air can intensify this effect. Replacing or repairing affected leading edges increases the inspection and maintenance costs and results in a shortening of the maintenance intervals. Thus, in regions with frequent sandstorms, leading edges made of carbon-fiber-reinforced plastic (CFRP) may be more badly affected than metallic leading edges.

In addition to the erosion of the leading edge, the icing of the leading edge during flight operation can also influence the aerodynamics of the aircraft wings. For de-icing the leading edge and for preventing the buildup of ice deposits, hot bleed air is conventionally directed from the inner surface of the wing to the leading edge. The de-icing, i.e. the melting of adhering ice that has already formed or prophylactic heating of the leading edge to prevent ice crusts, is energy-intensive. Usually, the bleed air from the so-called “piccolo tube”, which runs along the entire length of the wing on the inner surface of the leading edge, is applied to the leading edge. The bleed air is discharged for example from the main turbojet engine, especially from one of the later compressor stages, and has a temperature of 500-800 °C. A heat exchanger reduces the temperature to approximately 180 °C during use in the piccolo tube. The arrangement of the corresponding air conduits increases the installation and maintenance costs and the overall weight of the aircraft or aircraft component.

### SUMMARY

Against this background, it is an object of the disclosure herein to provide a leading edge of an aircraft component and a process for the production thereof that reduces the tendency to erosion of the leading edge and enables particularly as and when required de-icing of the leading edge and the prevention of adhering ice thereon.

This object is achieved by a leading edge of an aircraft part and by a process for forming a leading edge of an aircraft part according to the subject matter herein.

In a first aspect of the disclosure herein, the leading edge of the aircraft part comprises at least one base layer, a functional layer applied on the base layer; and a final layer applied on the functional layer. The functional layer here comprises in each case at least one first layer formed from carbon nanotubes and at least one second layer formed from titanium particles and/or titanium nitride particles. The purpose of the carbon nanotubes (CNTs) here is to electrically conductively connect the titanium particles and/or titanium nitride particles of the at least one second layer. Combining titanium particles with hard titanium nitride particles has proven advantageous here as a way of achieving resistance to mechanical stresses caused by water droplets and sand particles and the accompanying erosion. The introduction of the carbon nanotubes may not only achieve erosion protection, but also electrical conductivity in a single structure. The carbon nanotubes form a conductive network that electrically connects the titanium and titanium nitride layers, thereby allowing the functional layer to be utilized for additional functions. The electrical conductivity of the carbon nanotubes enables efficient heating through Joule effects, as a result of which the functional layer at the same time is used for de-icing and thus eliminates the need for external heating systems such as bleed air. This can reduce energy consumption in the overall system and component weights. The electrically conductive functional layer can in addition also serve as a lightning-protection layer. In this context, it has proven advantageous that carbon nanotubes and titanium-based particles are fully compatible with the base layer formed preferably of fiber-reinforced plastic or metal, especially carbon-fiber-reinforced plastic (CFRP) or metal, which advantageously achieves stable adhesion of the layers and prevents delamination. A further advantage can be seen in that the thickness and composition of the individual layers can be adapted in a need-oriented manner to the specific requirements of the aircraft type or of the operating environment. For example, the strength of the functional layer in regions with high erosion stress can thus be adjusted, i.e. increased, to adapt it to the increased stresses. An advantage of the final layer is that it serves as a further protective or wear layer that can if necessary be renewed without having to replace the entire functional layer. This reduces maintenance and minimizes downtimes. The multifunctional design advantageously eliminates the need to have to provide additional systems such as copper mesh for lightning protection or bleed-air systems for de-icing. This contributes to reducing weight and complexity of the aircraft or aircraft component.

In the context of the disclosure herein, a leading edge or leading edge of an aircraft part is understood as meaning the foremost edge of aerodynamic components that have first contact with the air flow. In the context of aircraft, these include for example the wings, empennages, fuselage tips or coverings and claddings. However, the disclosure herein is not limited thereto, but is employable in equal measure on the leading edges of aerodynamic components of stationary systems, such as for example on the blades or blade leading edges of wind turbines or on vehicles in all areas of transport, for example for road vehicles, for rail vehicles or for watercraft.

In the context of the disclosure herein, circular or cylindrical “tubes” or “tubelets” consisting of carbon atoms and generally having a single “wall” (SWCNTs) or multiple “walls” (MWCNTs) are referred to as carbon nanotubes. The carbon nanotubes can be produced for example in one of the following processes: arc discharge, laser ablation, high-pressure carbon monoxide disproportionation or chemical vapor deposition (CVD). Carbon nanotubes can be produced in various sizes, typically between 0.4 and 3 nm in diameter and between 20 and 1000 nm in length. Carbon nanotubes have high electrical conductivity and high thermal conductivity as well as good mechanical properties and exhibit no material incompatibilities with for example CFRP materials. In the context of the disclosure herein, the carbon nanotubes are arranged randomly in the functional layer and electrically conductively connected to the titanium or titanium nitride particles to form a web or network.

A further aspect of the disclosure herein lies in a process for forming a leading edge of an aircraft part, especially a leading edge as described above. The process here comprises: providing a base layer, forming a functional layer through sequential deposition of carbon nanotubes on the base layer and sequential deposition of titanium particles and titanium nitride particles on the deposited carbon nanotubes to form layers electrically conductively connected to the carbon nanotubes; and the forming of a final layer through deposition of titanium particles on the functional layer. Preferably, the final layer is formed as a coating, i.e. with a reduced layer thickness compared to the other layers. It is advantageous to build up the leading edges or layer structure layer-by-layer by sequential application of the carbon nanotubes, titanium particles and titanium nitride particles while simultaneously crosslinking the layers formed. This advantageously permits precise control of the layer thickness and composition, thereby allowing the functional layer to be adapted to specific requirements (for example mechanical stresses, electrical conductivity). The structured buildup of the functional layer on the base layer ensures optimum adhesion of the layers. Moreover, the use of carbon nanotubes as a connecting layer between titanium and titanium nitride particles advantageously ensures high mechanical and thermal stability; in the web that is obtained, the electrically conductive connection of the titanium and titanium nitride layers ensured by the carbon nanotubes achieves even heating of the functional layer in the context of the desired de-icing function. At the same time, the combination of titanium particles and hard titanium nitride particles ensures erosion protection at the leading edge, thereby achieving the advantageous dual function in the functional layer. The process advantageously allows sequential production of the functional layer and final layer in a single process sequence, which reduces the production costs. A further advantage can be seen in that the thickness of the carbon nanotube, titanium and titanium nitride layers in the process according to the disclosure herein are adapted to the requirements of the respective application in that, for example, thicker titanium or titanium nitride layers can be provided in the case of aircraft used in regions with high levels of particles (dust, sand). The further titanium particle layer envisaged as the final layer advantageously provides a renewable final layer, thus making easier maintenance possible. The integration of erosion protection and the de-icing function in the functional layer advantageously reduces the overall weight of the aircraft or of the individual components, since it is possible to dispense with complex bleed-air systems and the associated conduits and heat exchangers in particular.

A further aspect of the disclosure herein lies in an aircraft having an aircraft part that has a leading edge according to the disclosure herein, the aircraft part being designed as an aircraft wing, aircraft wing section, empennage section or fuselage section. It is considered to be an advantage that the leading edge according to the disclosure herein, which integrates erosion protection, de-icing function and optionally lightning protection in a single element, results in a significant simplification in construction. The integration thus affords savings in weight, installation space and additional systems such as bleed-air conduits or lightning protection mesh. It has also proven advantageous that the embodiment can be flexibly applied to different aircraft parts such as wings, empennages or fuselage sections that have first and main contact with the air flow during flight operation. The smooth and stable surface structure of the leading edge according to the disclosure herein and the possibility of swift and efficient de-icing advantageously reduces the air resistance and improves the aerodynamic efficiency of the aircraft.

Advantageous embodiments and developments will be apparent from the description, making reference to the figures.

In a further aspect of the disclosure herein, a coating formed from titanium particles is provided as a final layer. It has proven advantageous that the titanium particles of the final layer increase the resistance to mechanical stresses, in particular by water droplets, sand or dust particles hitting the leading edge, and protect the underlying functional layer from damage. It is likewise advantageous that the titanium final layer can be selectively renewed in the event of wear or damage without having to remove or treat the layers underneath. The titanium final layer thus advantageously contributes to the mechanical stability and robustness of the leading edge and can in addition also serve as an additional lightning-protection layer. It also supplements the electrical conductivity of the underlying functional layer and promotes the optimal heat distribution so as to boost the efficiency of de-icing measures. It is optionally possible to apply a further layer of paint or resin on the final layer to improve the aerodynamic and visual or aesthetic characteristics.

In a further aspect of the disclosure herein, the layers of the functional layer and the final layer can be formed in a chemical vapor deposition (CVD) process or by electrophoretic deposition (EPD). It has proven advantageous here that both the chemical vapor deposition process and electrophoretic deposition permit precise control of the layer thickness and composition, thereby allowing the properties of the functional layer (for example conductivity, erosion protection) and of the final layer to be adapted to the respective requirements. In addition, it is advantageous that the abovementioned processes achieve the build-up of even and homogeneous layers, thereby increasing the quality and performance of the layers. Advantageously, both processes are versatile and permit the deposition of various materials such as carbon nanotubes, titanium and titanium nitride in the functional layer. While the chemical vapor deposition process has proven advantageous particularly in the use of gaseous precursors, electrophoretic deposition permits the processing of particle suspensions. With electrophoretic deposition it is advantageously possible to sequentially deposit a plurality of layers (for example carbon nanotubes, titanium, titanium nitride) in a single process sequence, thus reducing the production time. The chemical vapor deposition process on the other hand permits the deposition of high-density, chemically stable layers that are particularly suitable for extreme environmental conditions. It is also optionally possible to combine chemical vapor deposition process and electrophoretic deposition within a production process in order to achieve improved adaptation to different material properties and application requirements. Thus, the chemical vapor deposition process can be used for example for the formation of the carbon nanotube layer and electrophoretic deposition for the deposition of titanium and titanium nitride particles, without limiting the disclosure herein thereto.

In a further embodiment of the disclosure herein, the base layer is formed of metal or a fiber-reinforced, especially carbon-fiber-reinforced, plastic material, where the fiber-reinforced plastic material preferably comprises a plurality of layers in which the fibers are in each layer differently aligned, preferably with an offset of between 45° and 90° from one layer to the next. The base layer made of metal advantageously provides high strength and stability, particularly in high-stress regions of the leading edge. In the case of a base layer made of carbon-fiber-reinforced plastic (e.g. CFRP), the offset fiber alignment in the individual layers ensures a more isotropic distribution of the mechanical stresses, thereby increasing the resistance to fatigue and impact stress. The use of a carbon-fiber-reinforced plastic material instead of metal also contributes advantageously to a reduction in the weight of the aircraft part, thereby promoting lightweight construction concepts. Both materials – metal and carbon-fiber-reinforced plastic – are compatible with the layers of the functional layer described above and thus permit stable build-up of the functional layer. The fiber alignment here depends on the number of stacked layers and can preferably vary in a range of between 45° and 90°. The offset fiber alignment in the carbon-fiber-reinforced plastic material offers the further advantage of being able to achieve increased resistance to dynamic stresses and vibrations, as occur in aircraft structures. Metal as base layer on the other hand offers as an advantage high fatigue resistance and thus prolongs the service life of the aircraft component. The choice between metal and fiber-reinforced plastic advantageously makes it possible to adapt the base layer to the requirements of the specific aircraft part (for example wing, empennage, fuselage).

In a further embodiment of the disclosure herein, the functional layer can be connected to a power source. The connection of the functional layer to a power source in order to achieve the direct heating of the layers by Joule effects has proven advantageous. The electrical conductivity of the carbon nanotubes advantageously ensures an even and swift heat distribution in the layers and prevents the formation of ice or contributes to the effective melting of adhering ice already present, so as to guarantee the aerodynamics of the aircraft. Compared to conventional de-icing systems, such as bleed-air systems, the electrical de-icing is by virtue of the functional layer significantly more energy-efficient, since it selectively warms just the leading edge. The power source can here be advantageously designed such that it provides variable power levels in accordance with de-icing requirements. This allows adaptation to different weather conditions or specific aircraft requirements. The swift and selective activation of the de-icing function also advantageously reduces the risk of ice forming on the leading edge and thus improves the aerodynamics. A further advantage can be seen in that the electrical de-icing system provided via the functional layer requires less maintenance than conventional bleed-air systems, since the latter require complex piping systems and heat exchangers. The power source can moreover be seamlessly integrated into existing aircraft electrical systems.

In a further embodiment of the disclosure herein, the functional layer is formed as an electrically heatable layer. The electrically heatable functional layer advantageously permits selective heating of the leading edge, which can prevent ice formation or allows existing ice to be melted swiftly and efficiently. Heat is distributed evenly over the functional layer, which advantageously increases the effectiveness of the de-icing system and at the same time avoids local overheating. Electric heating responds significantly more swiftly than conventional bleed-air systems. This is especially beneficial in the event of sudden changes in weather or in critical conditions during the flight. In addition to de-icing, the electrically heatable functional layer can also be utilized as protection against icing during the flight (anti-icing). It can also be seen as advantageous that an electric heating system converts energy directly into heat and thus reduces the energy requirement, especially compared to bleed-air systems, which withdraw considerable amounts of energy from the engines. The power of the electrically heatable layer can also be variably regulated according to weather conditions or aircraft requirements. In the leading edge according to the disclosure herein, carbon nanotubes form a highly conductive network that electrically connects the titanium and titanium nitride layers together, thereby creating a continuous and reliable electrical conduction pathway within the functional layer. This electrical conductivity advantageously permits the efficient utilization of the layers for functions such as de-icing and lightning protection. Carbon nanotubes also have high thermal conductivity. In combination with the titanium-containing layers, they improve the heat transfer and distribution in the functional layer, which advantageously ensures even heating of the leading edge. Carbon nanotubes lastly also ensure that the titanium-containing layers interact synergistically so as to ensure protection against both erosion and icing.

In a further embodiment of the disclosure herein, the deposition in the process takes place in a chemical vapor deposition process or by electrophoretic deposition. The chemical vapor deposition process is based on the thermal decomposition of gaseous starting materials that react chemically on the substrate surface, thereby forming a coating. It is particularly suitable for the deposition of thin, even layers with high purity and density. Electrophoretic deposition on the other hand involves transporting electrically charged particles in a liquid through an applied electric field to the surface of a substrate and depositing them there. It is particularly efficient for the production of multilayer structures from particles.

The procedure for a chemical vapor deposition process for forming the leading edge is described below by way of example and without limiting the disclosure herein thereto: After the optional preparation of the surface of the base layer by cleaning to remove impurities and ensure good adhesion, the base layer is made available in a CVD reactor. For the deposition of carbon nanotubes, a carbon-containing gas (e.g. methane, ethylene or acetylene) is supplied to the CVD reactor at temperatures of, for example, 500-900 °C, resulting in growth of the carbon nanotubes directly on the base layer through catalytic decomposition of the gas. The density and orientation of the carbon nanotubes can be controlled here by the process parameters. For the deposition of titanium nitride particles on the layer formed from carbon nanotubes, titanium tetrachloride (TiCl₄) and ammonia (NH₃) are supplied in the next step to the reactor at temperatures of, for example, 700-900 °C, resulting in the chemical reaction between TiCl₄ and NH₃ to form an even titanium nitride layer on the carbon nanotubes. For the deposition of titanium particles on the formed layer of carbon nanotubes and/or titanium nitride, titanium tetrachloride (TiCl₄) and hydrogen (H₂) are supplied to the reactor as reactants. The reaction takes place at moderate temperature, in order to produce a thin titanium layer. The coating with titanium particles envisaged as the final layer can be carried out in the same way.

The procedure for an electrophoretic deposition for forming the leading edge is described below by way of example and without limiting the disclosure herein thereto: After the optional preparation of the surface of the base layer by cleaning to remove impurities and ensure good adhesion, the base layer is made available. In addition, for each of the layers to be formed (carbon nanotubes, titanium particles, titanium nitride particles), a stable suspension is provided, optionally with addition of dispersants. For the deposition of the carbon nanotubes, the base layer is immersed as an anode (positively charged) or cathode (negatively charged) in a suspension containing charged carbon nanotubes, wherein, after applying an electric field (for example between 10-100 V), the carbon nanotubes migrate to the substrate surface of the base layer and form a homogeneous layer. For the deposition of the titanium particles, the base layer with applied carbon nanotubes is immersed in the suspension containing electrically charged titanium particles and the particles are deposited on the previously formed layer of carbon nanotubes through an applied electric field.

For the deposition of the titanium nitride particles, the base layer with applied carbon nanotubes and titanium particles is immersed in the suspension containing electrically charged titanium nitride particles and the particles are deposited on the previously formed layers through an applied electric field. It is of course also possible for the deposition of the titanium nitride and titanium particles to take place in reverse order. Also optionally possible is the formation of a plurality of layers of carbon nanotubes, titanium nitride and titanium particles. The coating of titanium particles forming the final layer is deposited in an analogous manner by electrophoretic deposition from a suspension containing charged titanium particles. At the end of the electrophoretic deposition, the leading edge is optionally dried or sintered to increase the mechanical stability. When employing electrophoretic deposition, it is advantageous for a plurality of layers to be deposited in a sequential operation in which the thickness and density of the layers can be controlled by process parameters such as voltage and time.

In a further embodiment of the aircraft according to the disclosure herein, the leading edge can formed as a separate element, which can be attached to the aircraft part, or can be formed directly on the aircraft part. The advantage of forming the leading edge as a separate element, which can be attached to the aircraft part, is that the leading edge can be produced independently of the main component and when necessary be replaced without having to replace the entire aircraft part. This simplifies the assembly and replacement of the leading edge, especially in heavily stressed regions of the wings or empennages. The leading edge can moreover be advantageously produced in a separate production process in the chemical vapor deposition process or by electrophoretic deposition, it being possible for the leading edges to be adapted to the envisaged conditions of use (for example high erosion protection or de-icing). It is also advantageous that the aircraft part itself does not have to be integrated into the coating processes, which simplifies production and handling. The advantage of direct formation of the leading edge on the aircraft part is that the leading edge can be connected to the component seamlessly and without additional fastening structures. This advantageously enhances the structural integrity of the aircraft part. A further advantage of the direct formation of the leading edge according to the disclosure herein is the adaptability of the respective layers to the specific geometry of the aircraft part.

### BRIEF DESCRIPTION OF THE DRAWINGS

The disclosure herein will be explained more particularly with reference to example embodiments, which are illustrated in the appended drawings. In the figures:

FIG. 1 shows a perspective view of an aircraft with a detailed section view of the leading edge of an aircraft wing;

FIG. 2 shows a cross-sectional view of a leading edge of an aircraft wing with a de-icing apparatus according to the prior art;

FIG. 3 shows a cross-sectional view of a leading edge of an aircraft wing with a detailed view of the structure of a leading edge according to an embodiment of the disclosure herein;

FIG. 4 shows a schematic representation of the process for forming a leading edge of an aircraft part according to an embodiment of the disclosure herein;

FIG. 5 shows a cross-sectional view of a leading edge of an aircraft wing with a detailed view of the structure of a leading edge according to an embodiment of the disclosure herein that can be used for de-icing; and

FIG. 6 shows a block representation of process steps of the process for forming a leading edge of an aircraft part according to an embodiment of the disclosure herein.

### DETAILED DESCRIPTION

The appended drawings serve for the further understanding of the disclosure herein and are part of this description. The drawings illustrate the embodiments of the disclosure herein and, together with the description, serve for elucidation of the principles of the disclosure herein. Other embodiments of the disclosure herein and many of the intended advantages of the disclosure herein will become apparent when these are elucidated with reference to the detailed description. The elements in the drawings are not necessarily true to scale. In the figures, the same reference signs denote components that are the same or have the same function, unless otherwise stated.

Although specific embodiments are illustrated and described, a person skilled in the art will recognize that a multiplicity of alternative and/or equivalent embodiments can be employed instead of the illustrated and described specific embodiments, without this resulting in departure from the scope of the disclosure herein. In general, this application is intended to cover all adaptations or variations of the specific embodiments described herein.

In the figures, identical elements, features and components that have the same function and the same effect are given the same reference signs unless otherwise stated.

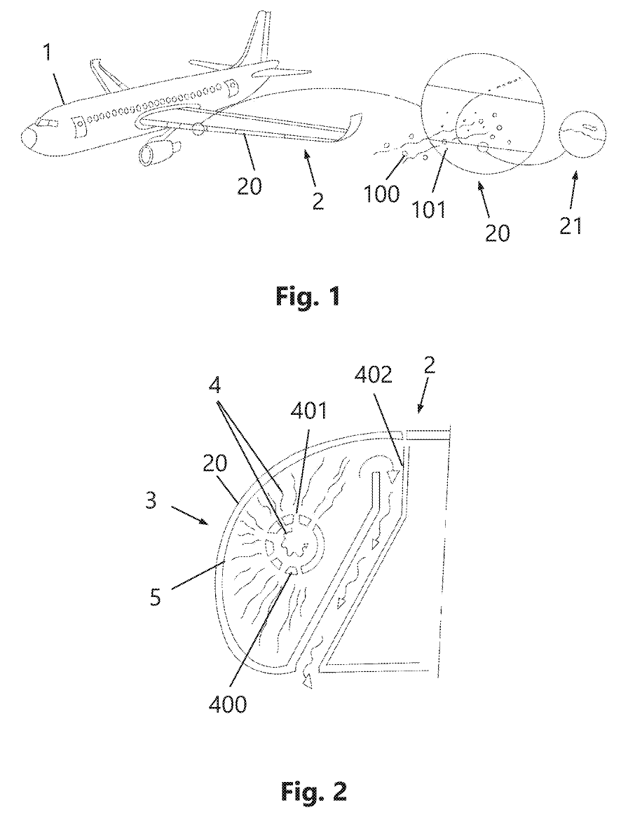

FIG. 1 shows a perspective view of an aircraft 1 with a detailed section view of the leading edge 20 of an aircraft wing 2 according to the prior art. The leading edge 20 shown enlarged in FIG. 1 does not feature the embodiment according to the disclosure herein and has only minimal erosion protection or none at all. During operation of the aircraft 1, the leading edge 20 comes into contact with the air flow and the water droplets 100 entrained therein and airborne particles 101, such as sand and dust. The water droplets 100 and airborne particles 101 hitting the leading edge 20 at high speed have a high abrasive potential and lead, particularly in the case of aircraft wings 2 made of CFRP material, to heavy erosion of the wing material in the region of the leading edge 20. This results in the erosion damage 21 which is shown in FIG. 1 left and can lead to an adverse effect on the aerodynamic characteristics of the aircraft wing 2.

FIG. 2 shows a cross-sectional view of a leading edge 20 of an aircraft wing 2 having a de-icing apparatus 3 according to the prior art. The growth of ice crusts on the leading edge 20 leads to the impairment of the aerodynamic characteristics of the aircraft wing 2, making in-flight de-icing or prophylactic heating of the leading edge 20 necessary in order to avoid adhering ice (anti-icing). The de-icing of the leading edge 20 or the heating thereof is effected by hot bleed air 4, which is conducted to the inner surface 5 of the leading edge 20. De-icing requires a high input of energy in order during de-icing to melt ice that has built up on the leading edge 20 or during anti-icing to prevent the buildup of ice deposits on the leading edge 20. The bleed air 4 is discharged from the so-called “piccolo tube” 400, which in the interior of the leading edge 20 runs along the entire length of the aircraft wing 2 from the opening 401 provided in the tube. The bleed air 4 is normally obtained from the main turbojet engine, especially from one of the later compressor stages, and has a temperature of 500-800 °C. An upstream heat exchanger (not shown) reduces the temperature to approx. 180 °C during use in the piccolo tube 400. Conventional bleed-air systems require the installation of complex piping systems 402 for the inflow and outflow of the bleed air 4 and heat exchangers, thus increase the aircraft weight and reduce the energy efficiency of the aircraft 1.

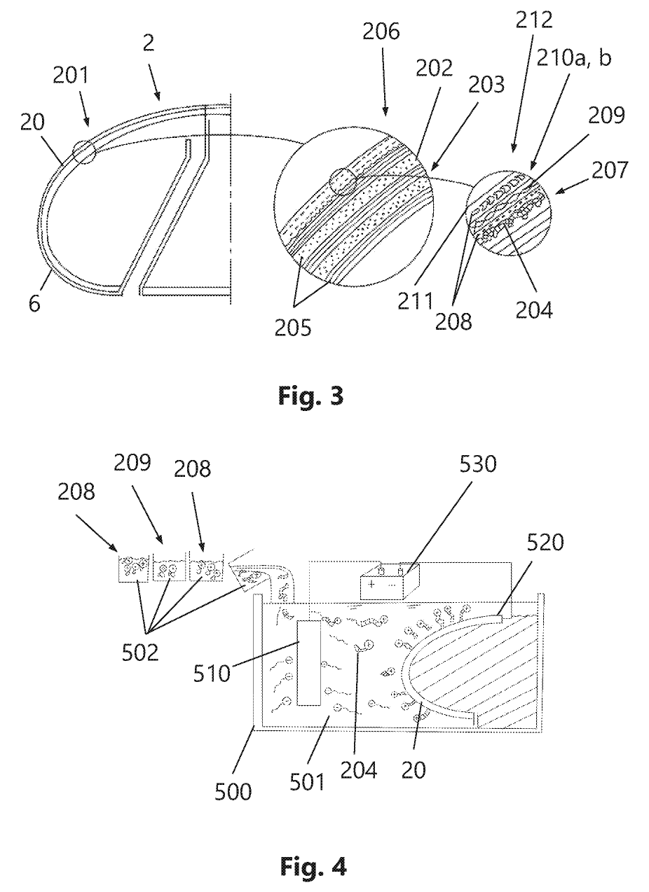

FIG. 3 shows a cross-sectional view of a leading edge 20 of an aircraft wing 2 with a detailed view of the structure of a leading edge 20 according to an embodiment of the disclosure herein. The leading edge 20 is provided with an erosion protection layer 201. The leading edge 20 comprises, as shown enlarged in the figure, a base layer 202 which is provided by the component, in the example embodiment the aircraft wing 2, and is formed of a plurality of layers 203 of a fiber-reinforced plastic material. The fibers 205 of the individual layers 203 are aligned offset to one another in each case by 90°. Configurations with a smaller offset, for example of 45° per layer, are also conceivable and dependent on the number of layers of fiber-reinforced plastic material and on the respective intended use of the component. Applied on the base layer 202 is a functional layer 206 which, as shown in a further magnification, in the example embodiment has a first layer 207 of non-directed carbon nanotubes 204 and formed directly on the base layer 202. Applied on the first layer 207 of carbon nanotubes 204 are second layers 210a, b formed from titanium particles 208 and titanium nitride particles 209. A coating 211 also consisting of titanium particles 208 forms the final layer 212 of the leading edge structure. This can optionally also be provided with a coating of paint or resin (not shown).

The second layers 210a, b formed from titanium particles 208 and titanium nitride particles 209 are electrically connected to one another through the carbon nanotubes 204, forming an electrically conductive web that can be charged with electrical current. When charged with electric current, the web heats up and releases the heat generated by the Joule effect to the surface 6 of the leading edge 20. As a consequence of the titanium nitride and titanium particles 208, 209 provided in the layer structure, there is accordingly, firstly, a reduction in the erosion at the leading edge 20 and, secondly, the introduction of electrically conductive carbon nanotubes 204 in connection with the metallic second layers 210a, b containing titanium and titanium nitride particles 208, 209 permits energy-efficient heating of the leading edge 20 for de-icing. The leading edge 20 thus has a multifunctional functional layer 206. The multifunctionality of the functional layer 206 brings weight savings, since the arrangement of de-icing apparatuses 3 utilizing bleed air 4 for de-icing the leading edge 20 can be dispensed with. The titanium/titanium nitride/carbon nanotube web can potentially also act as a lightning-protection layer on the leading edge 20, making further savings on space, costs and weight possible.

FIG. 4 shows a schematic representation of the process for forming a leading edge 20 of an aircraft part according to an embodiment of the disclosure herein. The formation of the leading edge 20 and of the functional layer 206 and of the final layer 212 by electrophoretic deposition of the respective layer formers is shown in greatly schematized form. An EPD tank 500 contains a colloidal liquid 501, an anode 520 and a cathode 510. Negatively charged carbon nanotubes 204 serve here as anions. If the circuit between anode 520 and cathode 510 is closed after a power source 530 has been connected, the anions accumulate at the anode 520. Positively charged cations accumulate at the cathode 510. In the example embodiment, carbon nanotubes 204 are deposited on the anode substrate, i.e. on the component or the leading edge 20. As an alternative to carbon nanotubes 204, the anions can consist of charged titanium or titanium nitride particles 208, 209. As an alternative to the anodic electrophoretic deposition shown here, cathodic electrophoretic deposition can also be employed, in which case the particles to be deposited must be negatively charged. The carbon nanotubes 204, titanium and titanium nitride particles 208, 209 respectively provided for the layers to be formed are each provided separately in stable suspensions 502, optionally with the addition of dispersants, and are admitted to the EPD tank 500 sequentially.

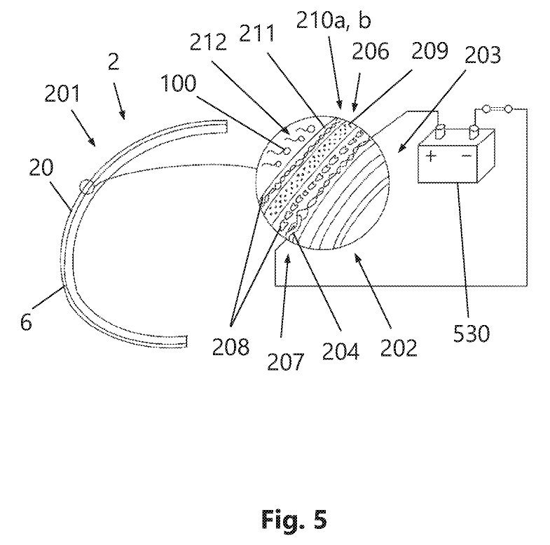

FIG. 5 shows a cross-sectional view of a leading edge 20 of an aircraft wing 2 with a detailed view of the structure of a leading edge 20 according to an embodiment of the disclosure herein that can be used for de-icing. The structure of the leading edge 20 corresponds to that already described in connection with FIG. 3 and reference is made to the elucidations provided there. Connecting a power source 530 to the first layer 207 formed from carbon nanotubes 204 and charging with electric current results in heating of the carbon nanotubes 204 and of the second layers 210a, b of the functional layer 206 that are electrically conductively connected thereto, and thus form an electrically conductive web. The heated web releases the heat generated by the Joule effect to the leading edge 20 and causes the melting of ice accumulations that have formed (de-icing) and prevents the formation of ice accumulations (anti-icing) on the outer surface 6 of the aircraft wing 2 or of the leading edge 20 as a result of water droplets 100 hitting the leading edge 20. The functional layer 206 thus simultaneously is used for erosion protection and de-icing of the leading edge 20.

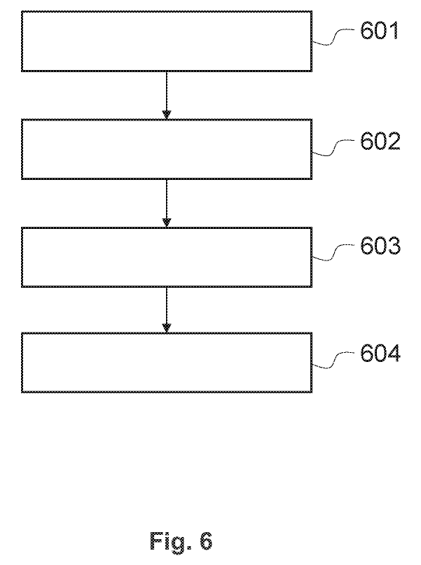

FIG. 6 shows a block representation of process steps of the process for forming a leading edge 20 of an aircraft part according to an embodiment of the disclosure herein. In step 601, a base layer 202 is provided. This can be an aircraft part, for example an aircraft wing 2 or a wing section. The base layer 202 can be made of a metallic or a CFRP material. In step 602, a functional layer 206 is formed through deposition of carbon nanotubes 204 on the base layer 202 and deposition of titanium particles 208 and titanium nitride particles 209 on the deposited carbon nanotubes 204. The deposition preferably takes place sequentially by electrophoretic deposition or in a chemical vapor deposition process. The deposition results in formation of metallic layers 210a, b that are electrically conductively connected to the carbon nanotubes 204. In a further step 603, a final layer 212 is formed through deposition of titanium particles 208 for coating the functional layer 209. In a subsequent step 604, a layer of paint or resin can be applied.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiments. In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Aircraft
2 Aircraft wing
3 De-icing apparatus
4 Bleed air
5 Inner surface
6 Surface
20 Leading edge
21 Erosion damage
100 Water droplets
101 Airborne particles
201 Erosion protection layer
202 Base layer
203 Layer
204 Carbon nanotubes
205 Fiber
206 Functional layer
207 First layer
208 Titanium particles
209 Titanium nitride particles
210a, b Second layer
211 Coating
212 Final layer
400 Piccolo tube
401 Opening
402 Piping system
500 EPD tank
501 Colloidal liquid
502 Suspension
510 Cathode
520 Anode
530 Power source
601 Step
602 Step
603 Step
604 Step

1. A leading edge of an aircraft part, comprising:
a base layer;
a functional layer applied on the base layer; and
a final layer applied on the functional layer,
the functional layer comprising in each case at least one first layer formed from carbon nanotubes and at least one second layer formed from titanium particles and/or from titanium nitride particles and the carbon nanotubes are provided to electrically conductively connect the titanium particles and/or titanium nitride particles of the at least one second layer.

2. The leading edge according to claim 1, comprising a coating formed from titanium particles as a final layer.

3. The leading edge according to claim 1, wherein the layers of the functional layer and the final layer can be formed in a chemical vapor deposition (CVD) process or by electrophoretic deposition (EPD).

4. The leading edge according to claim 1, wherein the base layer is formed of metal or a fiber-reinforced, or carbon-fiber-reinforced, plastic material, where the fiber-reinforced plastic material comprises a plurality of layers in which the fibers are in each layer differently aligned, with an offset of between 45° and 90° from one layer to the next.

5. The leading edge according to claim 1, wherein the functional layer can be connected to a power source.

6. The leading edge according to claim 1, wherein the functional layer is formed as an electrically heatable layer.

7. A process for forming a leading edge of an aircraft part, comprising:
providing a base layer;
forming a functional layer through sequential deposition of carbon nanotubes on the base layer and sequential deposition of titanium particles and titanium nitride particles on the deposited carbon nanotubes to form layers electrically conductively connected to the carbon nanotubes; and
forming a final layer through deposition of titanium particles on the functional layer.

8. The process according to claim 7, wherein the deposition takes place in a chemical vapor deposition (CVD) process or by electrophoretic deposition (EPD).

9. The process according to claim 7 used to form a leading edge of an aircraft part, the leading edge comprising:
the base layer;
the functional layer applied on the base layer; and
the final layer applied on the functional layer,
the functional layer comprising in each case at least one first layer formed from carbon nanotubes and at least one second layer formed from titanium particles and/or from titanium nitride particles and the carbon nanotubes are provided to electrically conductively connect the titanium particles and/or titanium nitride particles of the at least one second layer.

10. An aircraft having an aircraft part comprising the leading edge according to claim 1, the aircraft part being an aircraft wing, aircraft wing section, empennage section or fuselage section.

11. The aircraft according to claim 9, wherein the leading edge can be formed as a separate element, which can be attached to the aircraft part, or can be formed directly on the aircraft part.
